(19) United States
(12) Patent Application Publication
(10) Pub. No.: US 2023/0400682 A1
(43) Pub. Date: Dec. 14, 2023

(54) An Electro-Optical System and a Method of Designing the Same

(71) Applicant: Leonardo UK Ltd, London (GB)

(72) Inventor: Michael EDWARDS, London (GB)

(73) Assignee: Leonardo UK Ltd, London (GB)

(21) Appl. No.: 18/250,910

(22) PCT Filed: Oct. 28, 2021
(86) PCT No.: PCT/EP21/79967

§ 371 Date: Apr. 27, 2023

(30) Foreign Application Priority Data
Oct. 29, 2020 (GB) 2017140.1

(51) Int. Cl. G02B 27/00

(52) U.S. Cl. CPC G02B 27/0025; G02B 27/0012

(57) ABSTRACT

Many electro-optical systems include an environmental window that shield the sensor and optical train from environmental conditions. Where the electro-optical system is mounted on a high speed platform it can be necessary to shape the window away from the ideal optical shape of a hemisphere to one that is more aerodynamic. The optical train can include corrector elements to correct aberrations resulting from the non-ideal shape of the window. The exterior surface is configured to a specific biconic equation and that specified biconic equation is used to define the surfaces of the corrector element(s) of the optical train. This provides a more uniform wavefront error and magnification across the field of regard.

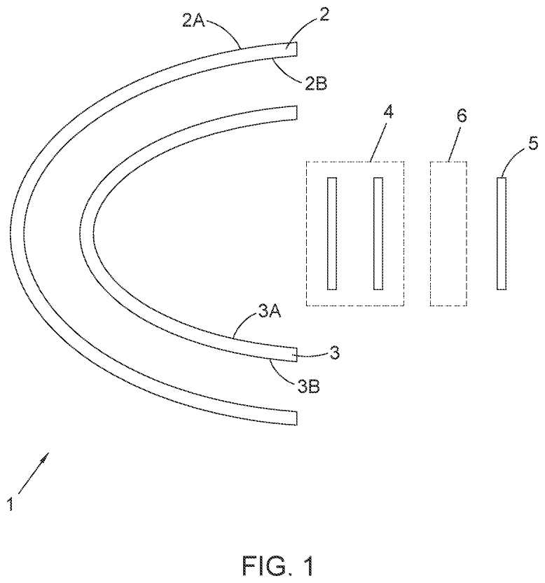

The present invention relates to an electro-optical system, and a method of designing the same that includes a focal plane array arranged to sense radiated optical energy from a scene and convert it to an electrical signal.

In many applications where such a system is deployed, the system includes an environmental window that shields the focal plane array and optical train from environmental conditions. A required characteristic of the environmental window is that it is transparent to operating wavelengths of the optical system.

The ideal optical geometries for an environmental window are planer or a spherical dome of uniform thickness as this ensures light is refracted uniformly to minimise aberrations such as coma and astigmatism which otherwise cause a blurred image on the focal plane array. This is especially important when the optical systems includes means to move the line of sight of the focal plane array to allow sensing over a wider field of regard.

Sometimes it is necessary to shape and/or size the environmental window away from the optical ideal to conform to other requirements of the host platform. Windows adapted in this way are known as conformal windows.

For example, in applications where the optical system is mounted on a platform intended to travel at high speed, a planer or hemisphere window can be detrimental to the aerodynamics of the platform.

Where the system is mounted in the nose of a platform, a solution commonly employed is to graduate a hemispherical environmental window into an ogive shape of the nose. Achieving a necessary fineness ratio of the ogive to give the desired aerodynamic performance often means compromising on the semi-diameter of the environmental window. Depending on how small a semi-diameter is needed it is often difficult or impractical to incorporate a steering mechanism into the system thus compromising the extent of the field of regard of the sensor apparatus.

An alternative solution is to use a window with a conformal external surface geometry that is more aerodynamic than a hemisphere, together with an optical corrector element having a geometry shaped to correct for the aberrations created as a result of the non-ideal optical geometry of the environmental window.

In the currently used method for designing a system using the latter solution, the desired conformal outer surface geometry of the environmental window is produced by optimising for the desired platform functionality, for example, aerodynamics. This geometry is modelled in a CAD package rather than a piece of optical design software, although certain constraints, e.g. maximum degree of curvature of the surface, may be applied.

The desired conformal outer surface geometry of the environmental window is modelled as a mesh grid. Then, a surface sagitta equation is constructed through the addition of further terms to a base biconic equation to define a surface that fits the points on the mesh of the desired surface geometry as accurately as possible.

The constructed equation is used to constrain the surfaces of the corrector element in order to correct for wavefront errors.

A problem is that even when a biconic equation provides a good fit with the point set, the surface defined by the equation may deviate from the manufactured exterior surface of the environmental window unpredictably in interstices between the points of the mesh grid. As a result, the corrector surfaces which are manufactured based on the biconic equation may not correct for wavefront error in these regions, leading to non-uniformity in wavefront error between these points.

According to the first aspect of the invention there is provided a method of designing an electro-optical system, the electro-optical system comprising:
a non-hemispherical, non-planar, environmental window;
a transmissive optical corrector;
an optical train;
a sensor disposed to receive optical rays that have passed through the window, optical corrector and optical train; and
a steering means adapted to steer the line of sight of the sensor about the field of regard;
wherein the method comprises designing the surface geometry of the environmental window and the surface geometry of the optical corrector using matched surface sagitta equations wherein the surface sagitta equations comprise:
a) the base biconic equation:

$$z = \frac{{c}_{x} {x}^{2} + {c}_{y} {y}^{2}}{1 + \sqrt{1 - ( 1 + {k}_{x} ) {{c}_{x}}^{2} {x}^{2} - ( 1 + {k}_{y} ) {{c}_{y}}^{2} {y}^{2}}}$$

in which:
Z is the Sagitta whereby z=0 is located at the intersection of the surface and optical axis; c is curvature in x or y where x and y are orthogonal directions about the optical axis; k is conic constant in x or y; and cₓ=1/Rₓ c_{y}=1/R_{y}, R is radius of curvature in x or y;
and
b) optionally one or more further terms that define aspheric and/or or free form deviations from the base biconic equation to provide a substantially uniform wavefront error and substantially uniform magnification across the field of regard.

At the root of the invention is the departure from the long standard practice of ‘fitting’ a biconic equation to a pre-designed exterior surface of an environmental window.

In contrast, by designing the exterior surface of environmental window to a specific biconic equation the exterior surface is defined by, rather than approximated by, the biconic equation. In this novel design process the biconic equation is developed, e.g. by adding further terms, to define a surface whose shape conforms to the other requirements of the host platform.

Then by using matched equations based on this biconic equation to define the surfaces of the corrector element a more uniform wave front error and magnification can be achieved across the whole field of regard compared with the prior art method.

For the purposes of this specification, biconic equations may be considered matched if they have the same number and form of meaningful additional terms, where an additional term is considered meaningful if it alters the sagitta of any point on the surface by more than 100 nm from the nominal base biconic equation.

It will be appreciated that the coefficients of the variables within one term of one matched equation will usually differ from the coefficients of variables within equivalent terms in another of the matched equations as the angle of curvature for each surface will differ because of the surface's relative position to the FPA. In the case of the surfaces of the corrector, this is due the need to correct for aberrations resulting from the deviation of the geometry of the external surface of the environmental window from the optical ideal.

A discovery that emerged from using this new design approach was that an environmental window with an exterior surface that does not deviate from the biconic equation, i.e. a surface defined by the biconic equation without meaningful further terms, in which cₓ=c_{y} and kₓ=k_{y} and having a fineness ratio above 1 provides unexpectedly good aerodynamic properties. An advantage of using such as surface is that it is easier to manufacture because less material needs to be removed. It also makes it easier to measure, e.g. to ensure the surface geometry has been accurately formed.

The method may further include manufacturing the environmental window and optical corrector.

The invention will now be described by way of example with reference to the figure, which illustrates a simplified schematic of an electro-optical system 1.

The system 1 comprises an environmental window 2, a static corrective element 3 that is transmissive in the waveband that the system 1 operates, an optical chain 4, a focal plane array (FPA) sensor 5 and a steering mechanism 6 to adjust the line of sight of the FPA 5 within the field of regard. The optical chain 4 is arranged to form an image of a scene on the FPA. The environmental window 2, optical corrector 3 and optical train 4 are all transmissive to the operating wavelengths of the optical system 1.

The specific type of steering mechanism 6 employed is unimportant and a number of suitable examples will be known to those skilled in the art including a gimballed steerable mirror.

In order to provide characteristics to meet requirements of the system's 1 host platform other than optical performance, e.g. improved aerodynamics, the geometry of the exterior surface 2A of the environmental window 2 is non-spherical and non-planar and is defined by the following surface sagitta equation:

$$Z = \frac{{c}_{x} {x}^{2} + {c}_{y} {y}^{2}}{1 + \sqrt{1 - ( 1 + {k}_{x} ) {{c}_{x}}^{2} {x}^{2} - ( 1 + {k}_{y} ) {{c}_{y}}^{2} {y}^{2}}}$$

also known as the base biconic equation, in which: Z is the Sagitta whereby z=0 is located at the intersection of the surface and optical axis; c is curvature in x or y where x and y are orthogonal directions about the optical axis; k is the conic constant in x or y; and cₓ=1/Rₓ and c_{y}=1/R_{y} where R is radius of curvature in x or y.

Optionally, to provide the necessary conformal characteristics, the surface sagitta equation may comprise one or more further terms that define aspheric and/or freeform deviations from the base biconic equation: e.g.:

$$z = \frac{{c}_{x} {x}^{2} + {c}_{y} {y}^{2}}{1 + \sqrt{1 - ( 1 + {k}_{x} ) {{c}_{x}}^{2} {x}^{2} - ( 1 + {k}_{y} ) {{c}_{y}}^{2} {y}^{2}}} + {\sum }_{i = 1}^{n} {α}_{i} {x}^{i} + {\sum }_{i = 1}^{n} {β}_{i} {y}^{i} + {\sum }_{i = 1}^{n} {A}_{i} {Z}_{i} ( ρ , φ )$$

where α, β are the i^{th} aspheric coefficients in X and Y, respectively. A is the i^{th} Zernike coefficient in ρ and φ, which define the radial distance from the optical axis and the radial angle, respectively.

Σᵢ₌₁ⁿαᵢxᵢ and Σᵢ₌₁ⁿβᵢyᵢ fly are examples of further terms that define aspheric deviations in x and y respectively. Σᵢ₌₁ⁿAᵢZᵢ(ρ, φ) is an example of a further term that defines a freeform deviation. The surface sagitta equation may comprise any number of any of these forms of further terms to provide the desired surface geometry depending on the surface characteristics required.

The geometries of the interior surface 2B of the environmental window, the inner surface 3A of the static corrector element 3 and outer surface 3B of the static corrector element are each defined by a separate surface sagitta equation that exactly match, i.e. have the same number of each form of further terms, the surface sagitta equation defining the geometry of the exterior surface 2A of the environmental window.

Within certain bounds of rate of change of curvature in both x and y, using matched equations to define the surface geometries of the environmental window and corrector element allows a substantially uniform wavefront error, which may be non-zero, across the field of regard, and minimises variation in magnification e.g. to within ≤5%, over the field of regard.

In an example application, the apparatus comprises a medium wave infrared (MWIR) FPA and the external surface 2A of the environmental window is conformal in order to provide improved aerodynamic performance. The environmental window 2 is comprised from a first material e.g. sapphire or sapphire like material. The static corrective element 3 is comprised from a second material, e.g. silicon, of a higher refractive index than the first material. The first and second materials have homogenous refractive indexes such that both the environmental window and corrector have uniform refractive indexes.

By using a higher refractive index material for the corrective element 3, the corrective element 3 can have a larger radius of curvature whilst still having the optical power necessary to compensate for wavefront errors resulting from the non-ideal geometry of the conformal environmental window. This maximises the space available for the steering mechanism.

A uniform wavefront error across the field of regard is particularly desirable as it allows the optical chain to substantially correct the wavefront error irrespective of the line of sight of the FPA within the field of regard.

In an example method of designing the system, a designer, e.g. an optical engineer manipulates the surface sagitta equation described above within certain bounds of rate of change of curvature in both x and y in order to define a surface geometry that conforms to one or more non-optical requirements of a host platform. For example, where the requirement is an improved aerodynamic surface, i.e. creates less drag, one or more prototype environmental windows may be created (e.g. physical and/or virtual models) having exterior surface geometries that are defined by variant surface sagitta equations that may provide the desired conformity. These prototypes (physical or virtual) are tested, e.g. in a wind tunnel or using computer modelling to determine which performs best in order to select the equation to use to define the exterior surface of the environmental window

Further surface sagitta equations are developed that match the selected equation in order to define the interior surface of the environmental window and the surfaces of the static corrector element. The value of the variables within each matching surface sagitta equation being manipulated to minimise variation in magnification across the field of regard and to provide a substantially uniform wavefront error across the field of regard.

The optical train 4 can then be designed to correct for the uniform wavefront error.

The environmental window 2 and optical corrector 3 are then manufactured to the design.

In an example design, each of the matching surface sagitta equations used to define the exterior and interior surfaces of the environmental window 2 and inner and outer surfaces of the corrective element 3, are based on the base biconic equation in which cₓ=c_{y}, kₓ=k_{y} and without any meaningful further terms, i.e. no further term that individually alters the sagitta at any point on the surface by more than 100 nm from the base biconic equation.

1. A method of configuring an electro-optical system, the electro-optical system including:
a non-hemispherical, non-planar, environmental window;
a transmissive optical corrector;
an optical train;
a sensor disposed to receive optical rays which pass through the window, optical corrector and optical train; and
a steering means configured to steer a line of sight of the sensor about a field of regard;
wherein the method comprises:
designing and configuring a surface geometry of the environmental window and a surface geometry of the optical corrector using matched surface sagitta equations, wherein the surface sagitta equations each include:
a) a base biconic equation:
$$z = \frac{{c}_{x} {x}^{2} + {c}_{y} {y}^{2}}{1 + \sqrt{1 - ( 1 + {k}_{x} ) {{c}_{x}}^{2} {x}^{2} - ( 1 + {k}_{y} ) {{c}_{y}}^{2} {y}^{2}}}$$
in which:
Z is the Sagitta, whereby z=0 is located at an intersection of a surface and optical axis; c is curvature in x or y, where in x and y are orthogonal directions about the optical axis; k is conic constant in x or y; and cₓ=1/Rₓ c_{y}=1/R_{y} R is radius of curvature in x or y; and
b) optionally, one or more further terms that define aspheric and/or or free form deviations from the base biconic equation;
to provide a substantially uniform wave front error and substantially uniform magnification across the field of regard; and
wherein surface sagitta equations are considered matched when they have a same number and form of meaningful additional terms, and where an additional term is considered meaningful when it alters the sagitta of any point on a surface by more than 100 nm from the base biconic equation.

2. A method according to claim 1, wherein the corrector is a static corrector.

3. A method according to claim 1, wherein the corrector has uniform refractive index.

4. A method according to claim 1, wherein cₓ=c_{y} and kₓ=k_{y}, and the surface sagitta equation includes no further meaningful terms.

5. An electro-optical system comprising:
a non-hemispherical, non-planar, environmental window;
a transmissive optical corrector;
an optical train;
a sensor disposed to receive optical rays that have passed through the window, optical corrector and optical train; and
a steering means configured to steer the line of sight of the sensor about the field of regard;
wherein a surface geometry of the environmental window and a surface geometry of the optical corrector are defined by matched surface sagitta equations wherein the surface sagitta equations each include:
a) a base biconic equation:
$$z = \frac{{c}_{x} {x}^{2} + {c}_{y} {y}^{2}}{1 + \sqrt{1 - ( 1 + {k}_{x} ) {{c}_{x}}^{2} {x}^{2} - ( 1 + {k}_{y} ) {{c}_{y}}^{2} {y}^{2}}}$$
in which:
Z is the Sagitta, whereby z=0 is located at an intersection of a surface and optical axis; c is curvature in x or y, where in x and y are orthogonal directions about the optical axis; R is radius of curvature in x or y; k is conic constant in x or y, and
b) optionally one or more further terms that define aspheric and/or or free form deviations from the base biconic equation;
such as to achieve a substantially uniform wave front error and substantially uniform magnification across the field of regard, and
wherein surface sagitta equations are considered matched when they have a same number and form of meaningful additional terms, and where an additional term is considered meaningful when it alters the sagitta of any point on a surface by more than 100 nm from the base biconic equation.

6. A method according to claim 1, wherein the surface sagitta equations each comprise:
b) one or more further terms that define aspheric and/or or free form deviations from the base biconic equation.

7. An electro-optical system according to claim 5, wherein the surface sagitta equations each comprise:
b) one or more further terms that define aspheric and/or or free form deviations from the base biconic equation.
